(19) United States
(12) Patent Application Publication
(10) Pub. No.: US 2015/0051756 A1
(43) Pub. Date: Feb. 19, 2015

(54) Aircraft System Control and Reporting via a Mobile Device

(71) Applicant: The Boeing Company, Chicago, IL (US)

(72) Inventors: Ethan Carl Owyang, Bothell, WA (US); David T. Kirkland, Normandy Park, WA (US)

(73) Assignee: THE BOEING COMPANY, Chicago, IL (US)

(21) Appl. No.: 13/966,960

(22) Filed: Aug. 14, 2013

(51) Int. Cl. B64C 19/00

(52) U.S. Cl. CPC B64C 19/00
USPC 701/3

(57) ABSTRACT

A method and apparatus for controlling a plurality of different systems on an aircraft. A mobile device is connected to an aircraft network on the aircraft. The mobile device is moveable to a plurality of different locations on the aircraft. The mobile device receives input from an operator identifying controls for controlling functions performed by the plurality of different systems on the aircraft. The controls are sent from the mobile device to the plurality of different systems on the aircraft via the aircraft network.

### BACKGROUND INFORMATION

1. Field

The present disclosure relates generally to systems and methods for controlling various systems on an aircraft and for reporting information from such systems. More particularly, the present disclosure relates to controlling various functions performed by different aircraft systems and reporting information from such systems using a mobile device.

2. Background

An aircraft may include various systems for performing various functions on the aircraft. Different systems on the aircraft may be configured to perform different functions on the aircraft. For example, without limitation, systems for performing various functions on an aircraft may include an in-flight entertainment system, a public address system, an information system, a cabin services system, an attendant call system, other aircraft systems, or various combinations of systems for performing various functions on the aircraft.

The functions performed by various systems on the aircraft may be controlled by a human operator. For example, without limitation, the functions performed by systems on the aircraft may be controlled by a member of the aircraft crew, a passenger on the aircraft, maintenance personnel, or any other appropriate operator.

An operator may control the functions performed by a system on an aircraft by interaction with an operator interface for the system. For example, the operator interface for a system on an aircraft may be configured to receive input from an operator and to control the functions performed by the system in response to the input from the operator.

The operator interface for a system on an aircraft may be a dedicated operator interface. A dedicated operator interface may be configured for controlling only the functions performed by a specific system on an aircraft. Functions performed by various different systems on an aircraft therefore may be controlled using various different dedicated operator interfaces.

Dedicated operator interfaces for systems on an aircraft may be connected to the systems by wires. Such dedicated operator interfaces may not be mobile or the mobility of such dedicated operator interfaces may be limited. For example, dedicated operator interfaces for systems on an aircraft may be mounted in fixed locations on the aircraft. Further, the number of dedicated operator interfaces for a system on an aircraft may be limited.

Accordingly, it would be desirable to have a method and apparatus that takes into account one or more of the issues discussed above as well as possibly other issues.

### SUMMARY

Embodiments of the present disclosure provide a method of controlling a plurality of different systems on an aircraft. A mobile device is connected to an aircraft network on the aircraft. The mobile device is moveable to a plurality of different locations on the aircraft. The mobile device receives input from an operator identifying controls for controlling functions performed by the plurality of different systems on the aircraft. The controls are sent from the mobile device to the plurality of different systems on the aircraft via the aircraft network.

Embodiments of the present disclosure also provide an apparatus comprising an aircraft network data processing system on an aircraft. The aircraft network data processing system is configured to receive controls for controlling functions performed by a plurality of different systems on the aircraft from a mobile device. The mobile device is moveable to a plurality of different locations on the aircraft. The aircraft network data processing system also is configured to deliver the controls received from the mobile device to the plurality of different systems.

Embodiments of the present disclosure also provide another method of controlling a plurality of different systems on an aircraft. An aircraft network data processing system on the aircraft receives controls for controlling functions performed by the plurality of different systems on the aircraft from a mobile device. The mobile device is moveable to different locations on the aircraft. The controls from the mobile device are delivered to the plurality of different systems by the aircraft network data processing system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 is an illustration of a block diagram of an apparatus for aircraft system control and reporting via a mobile device in accordance with an illustrative embodiment;

FIG. 2 is an illustration of a block diagram of a mobile device for aircraft system control and reporting in accordance with an illustrative embodiment;

FIG. 3 is an illustration of a block diagram of aircraft systems in accordance with an illustrative embodiment;

FIG. 4 is an illustration of a flowchart of a process for controlling aircraft systems via a mobile device in accordance with an illustrative embodiment;

FIG. 5 is an illustration of a flowchart of a process for aircraft system reporting via a mobile device in accordance with an illustrative embodiment;

FIG. 6 is an illustration of a flowchart of a process for aircraft system control and reporting in accordance with an illustrative embodiment; and

FIG. 7 is an illustration of a data processing system in accordance with an illustrative embodiment.

### DETAILED DESCRIPTION

The different illustrative embodiments recognize and take into account a number of different considerations. “A number”, as used herein with reference to items, means one or more items. For example, “a number of different considerations” means one or more different considerations.

The different illustrative embodiments recognize and take into account that the functions performed by systems on an aircraft may be controlled by operator interactions with dedicated operator interfaces for the systems. Such dedicated operator interfaces may be placed at a limited number of substantially fixed locations in the aircraft. Therefore, an operator may need to be at a location on the aircraft that is near the location of a dedicated operator interface, or move to such a location, to use the dedicated operator interface to control the functions performed by a system on the aircraft.

The different illustrative embodiments recognize and take into account that it may be desirable for an operator to be able to control the functions performed by a system on the aircraft from any appropriate location on the aircraft. Therefore, the different illustrative embodiments recognize and take into account that it may be desirable for an operator interface for controlling the functions performed by a system on an aircraft to be mobile.

The different illustrative embodiments recognize and take into account that dedicated operator interfaces for controlling the functions performed by systems on an aircraft may be connected by wires to the systems. The wired connections between the operator interfaces and the systems that are controlled by the operator interfaces may limit the mobility of the operator interfaces by an undesired amount. The different illustrative embodiments recognize and take into account that an operator interface configured for controlling the functions performed by a system on an aircraft via a wireless connection may be more mobile than an operator interface that is connected by wires to the system.

The different illustrative embodiments also recognize and take into account that a dedicated operator interface for controlling the functions performed by a system on an aircraft may not be used to control the functions performed by other different systems on the aircraft. Therefore, an operator may be required to use multiple different dedicated operator interfaces to control the functions performed by various different systems on the aircraft.

The different illustrative embodiments recognize and take into account that it may be desirable for an operator to be able to control the functions performed by various different systems on an aircraft using a single operator interface. The different illustrative embodiments also recognize and take into account that various systems on the aircraft may be configured to report various types of information to an operator. For example, a system on an aircraft may be configured to report information to an operator in response to a request from the operator.

Alternatively, or additionally, a system on an aircraft may be configured to report information to an operator automatically without a request from the operator for such information. For example, without limitation, a system on an aircraft may be configured to report information to an operator automatically on a periodic basis, in response to the occurrence of an event, or both on a periodic basis and in response to the occurrence of an event.

The different illustrative embodiments recognize and take into account that it may be desirable for an operator to be able to receive information reports from a system on an aircraft at any appropriate location on the aircraft using a mobile operator interface. The different illustrative embodiments also recognize and take into account that it may be desirable for an operator to be able to receive information reports from various different systems on an aircraft using a single operator interface. It also may be desirable that the information reports from aircraft systems that are received using a mobile operator interface may be viewed by an operator on the mobile operator interface.

Alternatively, or additionally, it may be desirable that information reports from aircraft systems that are received using a mobile operator interface may be stored on the mobile operator interface for later transfer to another device or system for analysis or for any other appropriate purpose or combination of purposes. For example, without limitation, it may be desirable that information reports from aircraft systems on a commercial passenger aircraft or other aircraft may be received using a mobile operator interface in accordance with an illustrative embodiment and may be stored on the mobile operator interface. The information reports from the aircraft systems that are stored on the mobile operator interface then may be transferred, at an appropriate time and in an appropriate manner, to a data processing system at the office of an airline or another appropriate location off board the aircraft for analysis or another appropriate purpose.

One or more of the illustrative embodiments provide a system and method for controlling the functions performed by systems on an aircraft via a mobile device. In accordance with an illustrative embodiment, an operator may use the mobile device to control the functions performed by various different systems on an aircraft from any appropriate location on the aircraft. The operator also may use the mobile device to receive information reports from various different systems on the aircraft at any appropriate location on the aircraft. The operator may use the mobile device to view the information reports received from the various different systems on the aircraft.

Alternatively, or additionally, the information reports received from the various different systems on the aircraft may be stored on the mobile device. For example, without limitation, the information reports received from the various different systems on the aircraft may be stored on the mobile device for analysis on the mobile device, for later transfer from the mobile device to another device or system for any appropriate use, or both.

In accordance with an illustrative embodiment, a wireless network on an aircraft may be configured to provide wireless connections for a number of mobile devices. Each of the mobile devices may be configured to allow an operator to identify controls for controlling the functions performed by various different systems on the aircraft. Controls for controlling the functions performed by various different systems on the aircraft may be sent from a mobile device at any appropriate location on the aircraft via a wireless connection to an aircraft network data processing system. The aircraft network data processing system may be connected to the various different systems on the aircraft via an aircraft network on the aircraft. The aircraft network data processing system may be configured to deliver the controls received from the mobile device via the wireless network to the appropriate systems on the aircraft via the aircraft network to control the functions performed by the systems.

Alternatively, or additionally, controls for controlling the functions performed by various different systems on an aircraft may be sent from the mobile device at any appropriate location on the aircraft via a wired connection to the aircraft network data processing system. In this case, the aircraft network data processing system may be configured to deliver the controls received from the mobile device via the wired connection to the appropriate systems on the aircraft via the aircraft network.

The aircraft network data processing system also may be configured to receive information reports from the various different systems on the aircraft via the aircraft network. The aircraft network data processing system may be configured to send the information reports received from various different systems on the aircraft to a mobile device at any appropriate location on the aircraft via the wireless connection to the mobile device provided by the wireless network on the aircraft. Alternatively, or additionally, the aircraft network data processing system may be configured to send the information reports received from various different systems on the aircraft to a mobile device at any appropriate location on the aircraft via a wired connection.

The mobile device may be configured to display, to an operator, the information reports from the various different systems on the aircraft that are received by the mobile device from the aircraft network data processing system via the wireless connection or the wired connection. Alternatively, or additionally, the mobile device may be configured to store, on the mobile device, the information reports from the various different systems on the aircraft that are received from the aircraft network data processing system. In this case, the mobile device also may be configured to transfer the information reports from the various different systems on the aircraft that are stored on the mobile device from the mobile device to another device or system.

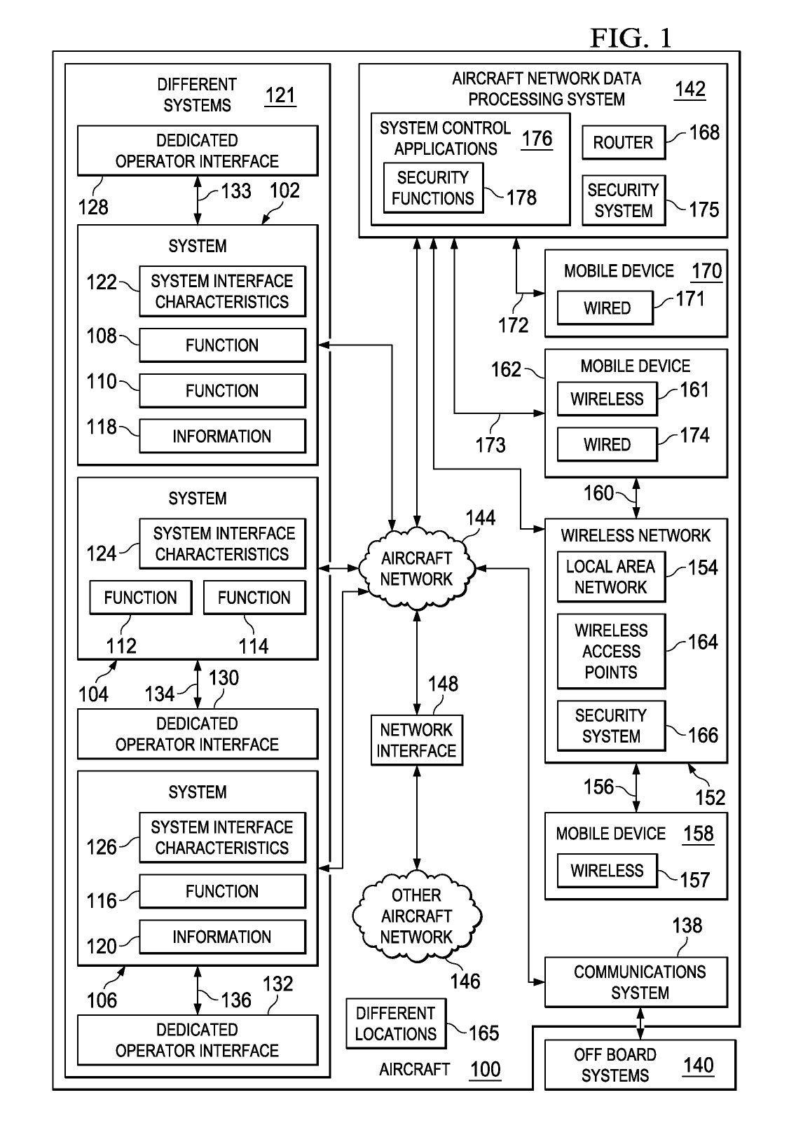

Turning to FIG. 1, an illustration of a block diagram of an apparatus for aircraft system control and reporting via a mobile device is depicted in accordance with an illustrative embodiment. In this example, aircraft 100 may be any appropriate type of aircraft. For example, without limitation, aircraft 100 may be a commercial or private passenger aircraft, a cargo aircraft, a military or other government aircraft, or any other aircraft configured for any appropriate purpose or mission. Aircraft 100 may be a fixed wing, rotary wing, or lighter than air aircraft.

Aircraft 100 may include various systems for performing various functions on aircraft 100. For example, aircraft 100 may include system 102, system 104, and system 106 on aircraft 100. Systems 102, 104, and 106 may comprise any appropriate systems for performing any appropriate functions on aircraft 100. Systems 102, 104, and 106 may be referred to as aircraft systems. Aircraft 100 in accordance with an illustrative embodiment may have more or fewer than three systems. The illustrative embodiments may be used to control the functions performed by any appropriate number of systems on an aircraft.

Systems 102, 104, and 106 may be configured to perform various functions on aircraft 100. For example, system 102 may be configured to perform function 108 and function 110 on aircraft 100. System 104 may be configured to perform function 112 and function 114 on aircraft 100. System 106 may be configured to perform function 116 on aircraft 100. Functions 108, 110, 112, 114, and 116 may comprise any appropriate functions that may be performed by any appropriate systems on aircraft 100. More or fewer than five functions may be performed by various systems on aircraft 100.

The illustrative embodiments may be used to control any appropriate number of functions performed by various systems on an aircraft. Various systems on aircraft 100 may be configured to report various types of information to an operator. For example, system 102 may be configured to report information 118 to an operator. System 106 may be configured to report information 120 to an operator. Information 118 and information 120 may comprise any appropriate types of information that may be reported to an operator by system 102 and system 106, respectively. For example, without limitation, information 118, information 120, or both, may comprise status information indicating the status of a system on aircraft 100, status information indicating the status of any appropriate number of functions performed by a system on aircraft 100, or any other appropriate type of information or combinations of various types of information that may be provided by a system on aircraft 100. Any appropriate number of systems on an aircraft may be configured to report any appropriate number of various types of information to an operator.

System 102 on aircraft 100 may be configured to report information 118 to an operator in response to a request from the operator. Alternatively, or additionally, system 102 on aircraft 100 may be configured to report information 118 to an operator automatically without a request from the operator for such information. For example, without limitation, system 102 on aircraft 100 may be configured to report information 118 to an operator automatically on a periodic basis, in response to the occurrence of an event, or both on a periodic basis and in response to the occurrence of an event.

Similarly, system 106 on aircraft 100 may be configured to report information 120 to an operator in response to a request from the operator, automatically without a request from the operator for such information, or both in response to a request from the operator and automatically without a request from the operator. In any case, the illustrative embodiments may be used by an operator to receive any appropriate number of reports of various types of information from any appropriate number of various systems on an aircraft.

Various systems on an aircraft may be configured to perform various different functions on the aircraft, to report different information, or both to perform various different functions on the aircraft and report different information. Any systems on an aircraft that are configured to perform different functions, to report different information, or both to perform different functions and to report different information may be different systems 121. For example, system 102, system 104, and system 106 are configured to perform different functions on aircraft 100 and to report different information. Therefore, system 102, system 104, and system 106 are different systems 121 on aircraft 100.

Each system on an aircraft may be defined by various system interface characteristics. The various system interface characteristics for a system on an aircraft may define the ways in which an operator may interact with the system to control the functions performed by the system, to receive the information reported by the system, or both to control the functions performed by the system and to receive the information reported by the system. For example, the system interface characteristics for a system on an aircraft may be defined by the functions that may be performed by the system and the ways in which the functions may be controlled by an operator. The system interface characteristics for a system on an aircraft also, or alternatively, may be defined by the information that may be reported by the system and the ways in which that information may be reported to an operator.

For example, system 102 on aircraft 100 may be defined by system interface characteristics 122. System 104 on aircraft 100 may be defined by system interface characteristics 124. System 106 on aircraft 100 may be defined by system interface characteristics 126. Different systems 121 on aircraft 100 may be configured to perform different functions, to report different information, or both to perform different functions and to report different information. Therefore, different systems 121 on aircraft 100 may have different system interface characteristics.

The system interface characteristics for a system on an aircraft may be used to implement an operator interface for the system. An operator interface for a system on an aircraft that is configured in accordance with the system interface characteristics for the system may allow an operator to interact with the system to control the functions performed by the system, to receive the information reported by the system, or both to control the functions performed by the system and to receive the information reported by the system.

For example, dedicated operator interface 128 may be configured in accordance with system interface characteristics 122 for system 102 on aircraft 100. Therefore, an operator may use dedicated operator interface 128 to control function 108 and function 110 performed by system 102 and to receive information 118 reported by system 102. Dedicated operator interface 130 may be configured in accordance with system interface characteristics 124 for system 104 on aircraft 100. Therefore, an operator may use dedicated operator interface 130 to control function 112 and function 114 performed by system 104. Dedicated operator interface 132 may be configured in accordance with system interface characteristics 126 for system 106 on aircraft 100. Therefore, an operator may use dedicated operator interface 132 to control function 116 performed by system 106 and to receive information 120 reported by system 106.

Each one of dedicated operator interfaces 128, 130, and 132 may be configured in accordance with system interface characteristics 122, 124, or 126 for only one corresponding system 102, 104, or 106 on aircraft 100. Therefore, each one of dedicated operator interfaces 128, 130, and 132 may be used to control and receive reports of information from only the corresponding system 102, 104, or 106 on aircraft 100 for which dedicated operator interface 128, 130, or 132 was configured. Therefore, an operator may be required to use multiple different dedicated operator interfaces 128, 130, and 132 to control and receive reports of information from the various different systems 121 on aircraft 100.

Dedicated operator interface 128 may be connected to system 102 by connection 133. Dedicated operator interface 130 may be connected to system 104 by connection 134. Dedicated operator interface 132 may be connected to system 106 by connection 136. For example, one or more of connections 133, 134, and 136 between dedicated operator interfaces 128, 130, and 132 and corresponding systems 102, 104, and 106 on aircraft 100 may be wired connections.

In this case, dedicated operator interfaces 128, 130, and 132 may not be mobile or may have limited mobility. For example, dedicated operator interfaces 128, 130, and 132 with wired connections 133, 134, and 136 to corresponding systems 102, 104, and 106 on aircraft 100 may be placed at a limited number of substantially fixed locations on aircraft 100. Therefore, an operator may need to be at a location on aircraft 100 that is near the location of one of dedicated operator interfaces 128, 130, and 132, or move to such a location on aircraft 100, to use one of dedicated operator interfaces 128, 130, or 132 to control or receive information reports from a corresponding one of systems 102, 104, and 106 on aircraft 100. Alternatively, one or more of connections 133, 134, and 136 between dedicated operator interfaces 128, 130, and 132 and corresponding systems 102, 104, and 106 on aircraft 100 may be wireless connections.

Communications system 138 may be configured to provide communications between aircraft 100 and off board systems 140. Communications system 138 may comprise any appropriate devices or systems for providing communications between aircraft 100 and off board systems 140 while aircraft 100 is in flight or on the ground. Off board systems 140 may include any appropriate number of systems that are not located on aircraft 100.

Aircraft network data processing system 142 may be connected to systems 102, 104, and 106 on aircraft 100 and to communications system 138 by aircraft network 144. Aircraft network 144 may be implemented in any appropriate manner to provide for the exchange of data between aircraft network data processing system 142 and systems 102, 104, and 106 on aircraft 100 and between aircraft network data processing system 142 and communications system 138. For example, aircraft network 144 may be implemented as an appropriate wired network on aircraft 100. Alternatively, appropriate portions of aircraft network 144 may be wireless.

Aircraft network 144 may be implemented as more than one network on aircraft 100. For example, without limitation, aircraft network 144 may be implemented as a network of appropriate networks on aircraft 100.

Aircraft network 144 may be connected to other aircraft network 146 by an appropriate network interface 148. Aircraft network data processing system 142 may exchange data with a system connected to other aircraft network 146 via aircraft network 144, network interface 148, and other aircraft network 146. For example, without limitation, aircraft network 144 and other aircraft network 146 may be associated with different levels of security on aircraft 100. For example, aircraft network 144 may comprise a relatively open data network configured for the exchange of data between various systems on aircraft 100 at a relatively low level of security. Other aircraft network 146 may be configured for the exchange of data between various other systems on aircraft 100 at a higher level of security. In this case, network interface 148 may be configured to maintain security between aircraft network 144 and other aircraft network 146 as data is exchanged between aircraft network 144 and other aircraft network 146.

Aircraft network data processing system 142 also may be connected to wireless network 152 on aircraft 100. Wireless network 152 may be implemented on aircraft 100 in any appropriate manner. For example, wireless network 152 may comprise local area network 154 or another appropriate wireless network on aircraft 100. For example, without limitation, wireless network 152 may comprise all or part of an integrated wireless network for an aircraft as described in U.S. Patent Application Publication No. 2011/0195656, which is incorporated herein by reference.

Wireless network 152 may be configured to provide wireless connection 156 for wireless 157 mobile device 158 and wireless connection 160 for wireless 161 mobile device 162. Wireless network 152 may be configured to provide wireless connections for any appropriate number of wireless mobile devices in accordance with an illustrative embodiment.

Wireless network 152 may comprise any appropriate number of wireless access points 164. For example, an appropriate number of wireless access points 164 may be provided at various locations in aircraft 100 so that mobile device 158 and mobile device 162 may establish and maintain wireless connection 156 and wireless connection 160, respectively, with wireless network 152 from a plurality of appropriate different locations 165 in aircraft 100.

Wireless network 152 may comprise security system 166. Security system 166 may be configured to determine whether mobile devices 158 and 162 are authorized to connect to wireless network 152. Security system 166 may be implemented in wireless network 152 in any appropriate manner.

Mobile device 158 and mobile device 162 may be configured to allow an operator to identify controls for controlling any number of functions 108, 110, 112, 114, and 116 performed by systems 102, 104, and 106 on aircraft 100. Such controls may be sent from mobile device 158 and mobile device 162 via wireless connection 156 and wireless connection 160, respectively, to wireless network 152.

The controls from mobile device 158 and mobile device 162 may be received by aircraft network data processing system 142 via wireless network 152. Aircraft network data processing system 142 may be configured to deliver the controls received from mobile device 158 and mobile device 162 via wireless network 152 to an appropriate one or more of systems 102, 104, and 106 to control one or more of functions 108, 110, 112, 114, and 116 performed by systems 102, 104, and 106. For example, aircraft network data processing system 142 may comprise router 168 that may be configured to route controls for controlling one or more of functions 108, 110, 112, 114, and 116 to the appropriate one or more of systems 102, 104, and 106 via aircraft network 144.

Aircraft network data processing system 142 also may be configured to receive reports of information 118 and information 120 from system 102 and system 106 on aircraft 100 via aircraft network 144. Aircraft network data processing system 142 may be configured to send the reports of information 118 and information 120 from system 102 and system 106 to mobile device 158 and mobile device 162 via wireless network 152.

Mobile device 158 and mobile device 162 may be configured to receive the reports from system 102 and system 106 on aircraft 100 via wireless connection 156 and wireless connection 160. Mobile device 158 and mobile device 162 also may be configured to display the reports received from system 102 and system 106 on aircraft 100 to an operator in an appropriate manner, to store the reports received from system 102 and system 106, or to both display and store the reports.

Mobile device 170 may be connected to aircraft network data processing system 142 by wired connection 172. Therefore, mobile device 170 may be referred to as wired 171 mobile device 170. Mobile device 170 may be configured to perform the same functions for system control and reporting as mobile device 158 and mobile device 162 from various different locations 165 on aircraft 100. However, mobile device 170 may be less mobile than mobile device 158 and mobile device 162.

Mobile device 162 also may be configured to be connected to aircraft network data processing system 142 by wired connection 173. Therefore, mobile device 162 also may be referred to as wired 174 mobile device 162. In this case, mobile device 162 may be both wireless 161 and wired 174. For example, without limitation, a laptop computer or other device used for maintenance of aircraft 100 may be an example of mobile device 162 that may be both wireless 161 and wired 174.

Aircraft network data processing system 142 may comprise security system 175. Security system 175 may be configured to determine whether mobile device 162 and mobile device 170 are authorized to communicate with aircraft network data processing system 142 via wired connection 173 and wireless connection 172, respectively. Security system 175 may be implemented in aircraft network data processing system 142 in any appropriate manner.

Security system 175 also may be used in the process for determining whether wireless ones of mobile device 158 and mobile device 162 may connect to wireless network 152. For example, in a certificate based implementation for providing security, security system 166 in wireless network 152 may hand authentication requests from wireless ones of mobile device 158 and mobile device 162 to security system 175 in aircraft network data processing system 142 for verification.

The system control and reporting functions provided to an operator by mobile devices 158, 162, and 170 may be defined by system control applications 176. For example, system control applications 176 may be stored by aircraft network data processing system 142. System control applications 176 may be downloaded by mobile device 158 and mobile device 162 from aircraft network data processing system 142 via wireless connection 156 and wireless connection 160, respectively, to wireless network 152. System control applications 176 then may be run on mobile devices 158 and 162.

Alternatively, system control applications 176 may be run on aircraft network data processing system 142. In this case, the functionality of system control applications 176 may be accessed by mobile device 158 and mobile device 162 via wireless connection 156 and wireless connection 160, respectively, to wireless network 152. Similarly, system control applications 176 may be downloaded to mobile devices 16 and mobile device 170 from aircraft network data processing system 142 for running on mobile device 162 and mobile device 170, or run on aircraft network data processing system 142 and accessed by mobile device 162 and mobile device 170 via wired connection 173 and wireless connection 172, respectively.

System control applications 176 also may provide appropriate security functions 178. For example, security functions 178 in system control applications 176 may be configured to determine whether mobile device 158, 162, or 170 is allowed to control or receive information from a particular system 102, 104, or 106 on aircraft 100.

The illustration of FIG. 1 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

For example, mobile devices 158, 162, and 170 may be configured to control systems 102, 104, and 106 on aircraft 100 by a direct connection from mobile devices 158, 162, and 170 to systems 102, 104, and 106 that does not include aircraft network data processing system 142 or wireless network 152.

Aircraft 100 is one example of a platform in which an illustrative embodiment may be implemented. System control via a mobile device in accordance with an illustrative embodiment may be implemented to control a plurality of different systems and functions in various platforms other than aircraft 100. Reporting via a mobile device in accordance with an illustrative embodiment may be implemented to provide reporting for a plurality of different systems in various platforms other than aircraft 100.

For example, the illustrative embodiments may be implemented to provide system control and reporting via a mobile device for various systems in a vehicle or other mobile platform that may be configured to travel through air, in space, on land, on the surface of water, underwater, or in any other medium or combination of media. The illustrative embodiments also may be implemented to provide system control and reporting via a mobile device for various systems in a non-mobile platform.

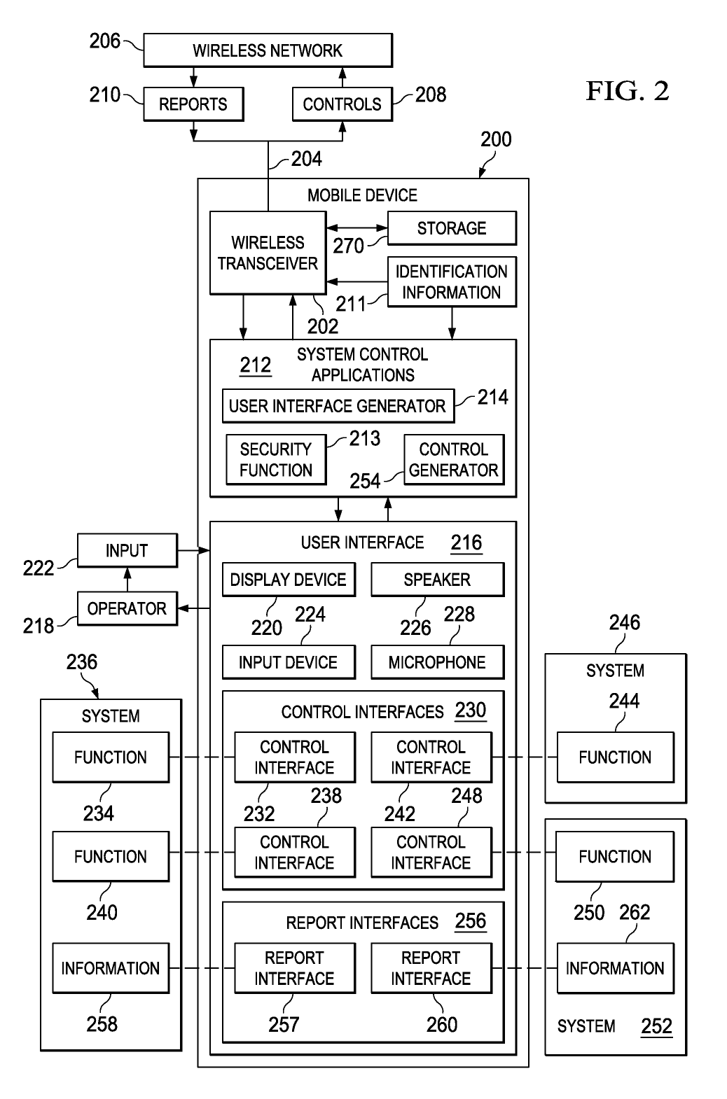

Turning FIG. 2, an illustration of a block diagram of a mobile device for aircraft system control and reporting is depicted in accordance with an illustrative embodiment. Mobile device 200 may be an example of one implementation of mobile devices 158, 162, and 170 in FIG. 1.

Mobile device 200 may include wireless transceiver 202. Wireless transceiver 202 may be configured to provide wireless connection 204 to wireless network 206. Therefore, mobile device 200 may be referred to as a wireless device. Wireless transceiver 202 may be configured to send controls 208 and other data to wireless network 206 via wireless connection 204. Wireless transceiver 202 also may be configured to receive reports 210 and other data from wireless network 206 via wireless connection 204.

Alternatively, or in addition, mobile device 200 may be configured to be connected to an aircraft network data processing system by an appropriate wired connection. In this case, controls 208 and other data may be sent to the aircraft network data processing system via the wired connection and reports 210 and other data may be configured to be received from the aircraft network data processing system via the wired connection.

Mobile device 200 may include identification information 211. Identification information 211 may be provided to wireless network 206 and used by a security system associated with wireless network 206 to determine whether mobile device 200 is authorized to connect to wireless network 206.

System control applications 212 may be run on mobile device 200. System control applications 212 may be loaded on mobile device 200 for running on mobile device 200 in any appropriate manner. For example, without limitation, system control applications 212 may be downloaded to mobile device 200 from wireless network 206 via wireless connection 204. Alternatively, system control applications 212 may be run on an aircraft network data processing system and accessed by mobile device 200 via wireless connection 204 to wireless network 206.

System control applications 212 may include security function 213. Security function 213 may be configured to determine whether mobile device 200 is allowed to use system control applications 212 to control particular systems on the aircraft or to receive reports 210 from such systems. For example, without limitation, security function 213 may be configured to use identification information 211 for mobile device 200 to determine whether mobile device 200 is allowed to send controls 208 to or receive reports 210 from particular systems on an aircraft.

System control applications 212 may include user interface generator 214. User interface generator 214 may be configured to generate user interface 216. User interface 216 may be displayed to operator 218 on any appropriate display device 220. Input 222 may be received from operator 218 via any appropriate input device 224. For example, without limitation, display device 220 and input device 224 may be combined in a single device, such as a touch screen display. Mobile device 200 also may comprise speaker 226 for presenting information to operator 218 in audible form. Mobile device 200 also may include microphone 228 for receiving input 222 from operator 218 by voice or in another audible form.

User interface 216 may comprise a number of control interfaces 230 for controlling functions performed by various different systems on an aircraft. For example, control interface 232 may be configured for controlling function 234 performed by system 236 on the aircraft. Control interface 238 may be configured for controlling function 240 performed by system 236 on the aircraft. Control interface 242 may be configured for controlling function 244 performed by system 246 on the aircraft. Control interface 248 may be configured for controlling function 250 performed by system 252 on the aircraft.

System control applications 212 may include control generator 254. Control generator 254 may be configured to generate controls 208 for controlling the functions performed by various systems on an aircraft in response to input 222 from operator 218 to control interfaces 230. Controls 208 generated by control generator 254 may be sent to the various systems on the aircraft via wireless connection 204 and wireless network 206.

For example, without limitation, a number of control interfaces 230 may be configured for controlling one or more of system 236, system 246, and system 252 to send reports 210 to mobile device 200. Alternatively, or in addition, one or more of system 236, system 246, and system 252, may be configured to send reports 210 to mobile device 200 in response to a request from operator 218 or from another entity that may be provided to one or more of system 236, system 246, and system 252 in another appropriate manner. Alternatively, or additionally, one or more of system 236, system 246, and system 252 may be configured to send reports 210 to mobile device 200 automatically on a periodic basis, in response to the occurrence of an event, or both on a periodic basis and in response to the occurrence of an event.

User interface 216 also may include report interfaces 256. Report interfaces 256 may be configured for displaying reports 210 received by mobile device 200 from various different systems on an aircraft. For example, without limitation, user interface generator 214 may be configured to generate report interfaces 256 in response to mobile device 200 receiving reports 210 via wireless connection 204 to wireless network 206. For example, report interface 257 may be configured to display a report of information 258 from system 236 on an aircraft. Report interface 260 may be configured to display a report of information 262 from system 252 on the aircraft.

Mobile device 200 also may be configured to store reports 210 received by mobile device 200 from various different systems on the aircraft. For example, reports 210 received by mobile device 200 may be stored in storage 270 on mobile device 200. Storage 270 may be implemented using any appropriate memory device or other device for storing reports 210 on mobile device 200. For example, without limitation, reports 210 may be transferred from storage 270 to another device or system for review and analysis at a later appropriate time.

The illustration of FIG. 2 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

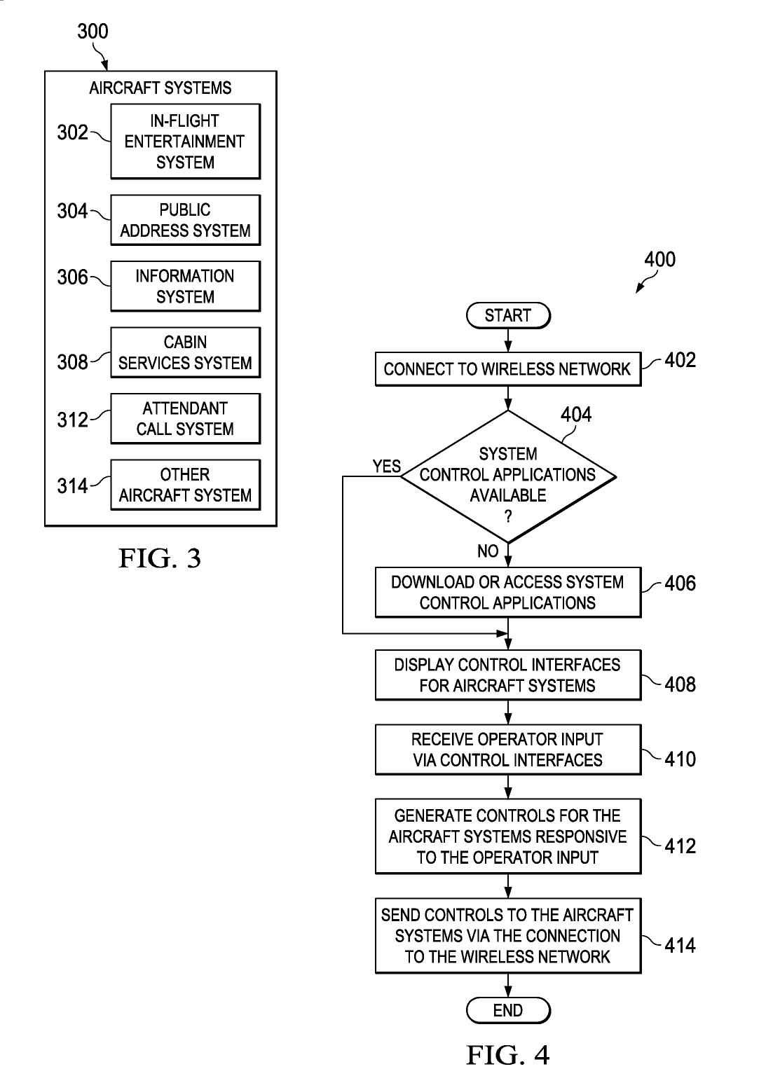

Turning to FIG. 3, an illustration of a block diagram of aircraft systems is depicted in accordance with an illustrative embodiment. In this example, aircraft systems 300 may be examples of implementations of system 102, system 104, and system 106 in aircraft 100 in FIG. 1.

Aircraft systems 300 may include in-flight entertainment system 302, public address system 304, information system 306, cabin services system 308, attendant call system 312, other aircraft system 314, or various combinations of systems on an aircraft. The various functions performed by aircraft systems 300 may depend on the aircraft on which aircraft systems 300 are implemented. Different functions and combinations of functions may be performed by different aircraft systems 300 on different aircraft. For example, without limitation, various functions performed by public address system 304 and attendant call system 312 may be included in cabin services system 308 in one implementation of aircraft systems 300.

Turning to FIG. 4, an illustration of a flowchart of a process for controlling aircraft systems via a mobile device is depicted in accordance with an illustrative embodiment. For example, process 400 may be implemented in mobile device 200 in FIG. 2.

Process 400 may begin by connecting the mobile device to a wireless network on an aircraft (operation 402). It then may be determined whether system control applications are available on the mobile device (operation 404). If system control applications are not available on the mobile device, system control applications may be downloaded or accessed by the mobile device via the wireless connection (operation 406).

The system control applications may be used to display control interfaces for controlling functions performed by various systems on the aircraft (operation 408). Operator input may be received via the displayed control interfaces (operation 410). Controls for controlling functions performed by various systems on the aircraft may be generated in response to the operator input (operation 412).

The controls then may be sent to the various systems on the aircraft via the connection to the wireless network (operation 414), with the process terminating thereafter. With reference again to operation 404, if the system control applications are available, the process proceeds to operation 408 as described above.

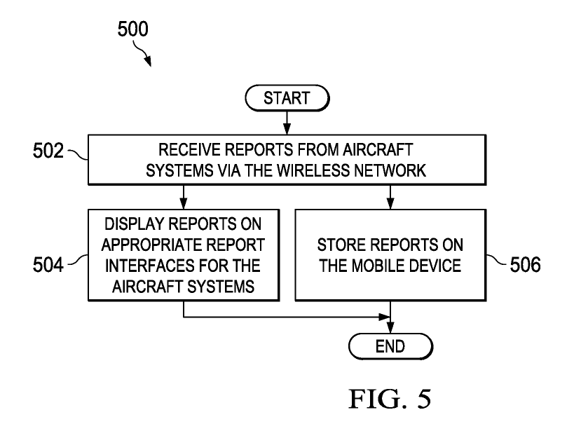

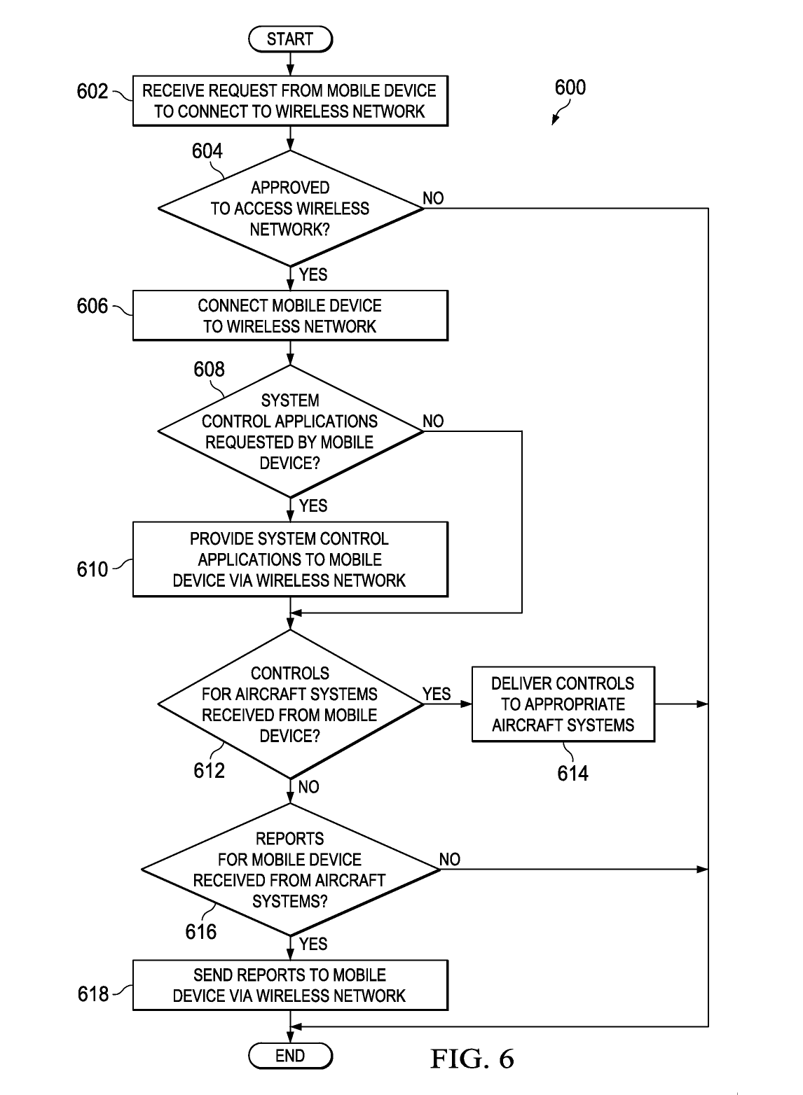

Turning to FIG. 5, an illustration of a flowchart of a process for aircraft system reporting via a mobile device is depicted in accordance with an illustrative embodiment. In this example, process 500 may be implemented in mobile device 200 in FIG. 2. Process 500 may be implemented by a system control application after the mobile device is connected to a wireless network on an aircraft.

Process 500 may begin by receiving reports from systems on an aircraft via the wireless network (operation 502). The received reports then may be displayed on appropriate report interfaces for the aircraft systems (operation 504), with the process terminating thereafter. Alternatively, or in addition, the received reports may be stored on the mobile device (operation 506), with the process terminating thereafter. For example, without limitation, the received reports may be stored on the mobile device and transferred from the mobile device to another device or system for review and analysis at a later appropriate time.

Turning to FIG. 6, an illustration of a flowchart of a process for aircraft system control and reporting is depicted in accordance with an illustrative embodiment. In this illustrative example, process 600 may be implemented in aircraft network data processing system 142 and wireless network 152 on aircraft 100 in FIG. 1.

Process 600 may begin by receiving a request from a mobile device to connect to a wireless network on an aircraft (operation 602). It may be determined whether the mobile device is approved to access the wireless network (operation 604). If it is determined that the mobile device is not approved to access the wireless network, the process terminates. If it is determined that the mobile device is approved to access the wireless network, the mobile device may be connected to the wireless network (operation 606).

It then may be determined whether system control applications are requested by the mobile device (operation 608). If system control applications are requested, the system control applications may be provided to the mobile device via the wireless network (operation 610).

It then may be determined whether controls for controlling the functions performed by systems on the aircraft are received from a mobile device (operation 612). In response to a determination that controls are received from a mobile device, the controls may be delivered to the appropriate aircraft systems (operation 614), with the process terminating thereafter.

If controls are not received from a mobile device, it may be determined whether reports for a mobile device are received from the aircraft systems (operation 616). If reports for a mobile device are not received from the aircraft systems, the process terminates. Otherwise, in response to receiving reports from the aircraft systems, the reports may be sent to the mobile device via the wireless network (operation 618) with the process terminating thereafter.

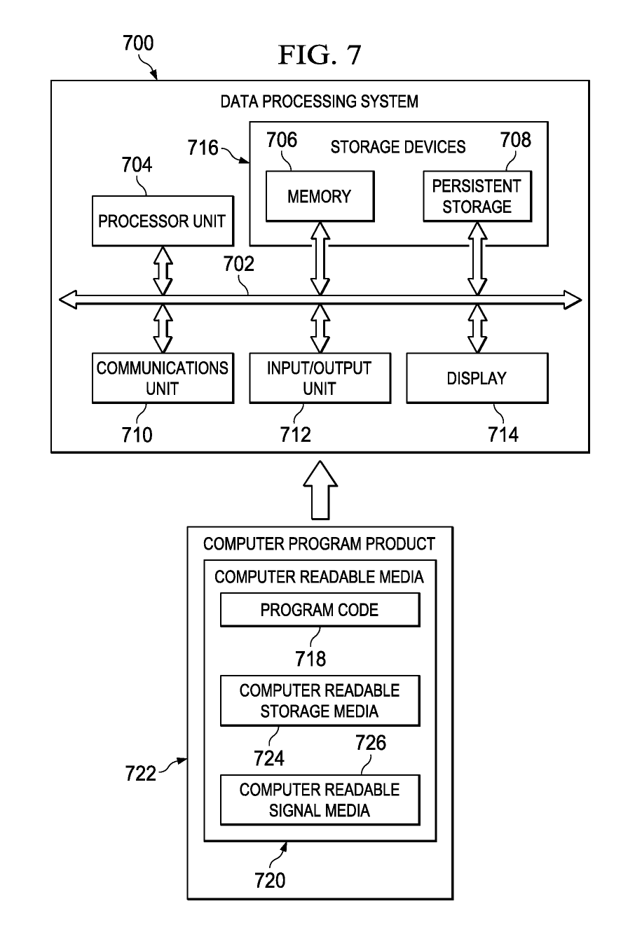

Turning now to FIG. 7, an illustration of a data processing system is depicted in accordance with an illustrative embodiment. Data processing system 700 may be an example of one implementation of aircraft network data processing system 142 in FIG. 1. Data processing system 700 also may be an example of one implementation of mobile device 200 in FIG. 2.

In this illustrative example, data processing system 700 includes communications fabric 702. Communications fabric 702 provides communications between processor unit 704, memory 706, persistent storage 708, communications unit 710, input/output (I/O) unit 712, and display 714. Memory 706, persistent storage 708, communications unit 710, input/output (I/O) unit 712, and display 714 are examples of resources accessible by processor unit 704 via communications fabric 702.

Processor unit 704 serves to run instructions for software that may be loaded into memory 706. Processor unit 704 may be a number of processors, a multi-processor core, or some other type of processor, depending on the particular implementation. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information such as, for example, without limitation, data, program code in functional form, and other suitable information either on a temporary basis or a permanent basis. Storage devices 716 may also be referred to as computer readable storage devices in these examples. Memory 706, in these examples, may be, for example, a random access memory or any other suitable volatile or non-volatile storage device. Persistent storage 708 may take various forms, depending on the particular implementation.

Persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications fabric 702. In these illustrative examples, the instructions are in a functional form on persistent storage 708. These instructions may be loaded into memory 706 for execution by processor unit 704. The processes of the different embodiments may be performed by processor unit 704 using computer-implemented instructions, which may be located in a memory, such as memory 706.

These instructions may be referred to as program instructions, program code, computer usable program code, or computer readable program code that may be read and executed by a processor in processor unit 704. The program code in the different embodiments may be embodied on different physical or computer readable storage media, such as memory 706 or persistent storage 708.

Program code 718 is located in a functional form on computer readable media 720 that is selectively removable and may be loaded onto or transferred to data processing system 700 for execution by processor unit 704. Program code 718 and computer readable media 720 form computer program product 722 in these examples. In one example, computer readable media 720 may be computer readable storage media 724 or computer readable signal media 726.

Computer readable storage media 724 may include, for example, an optical or magnetic disk that is inserted or placed into a drive or other device that is part of persistent storage 708 for transfer onto a storage device, such as a hard drive, that is part of persistent storage 708. Computer readable storage media 724 also may take the form of a persistent storage, such as a hard drive, a thumb drive, or a flash memory, that is connected to data processing system 700. In some instances, computer readable storage media 724 may not be removable from data processing system 700.

In these examples, computer readable storage media 724 is a physical or tangible storage device used to store program code 718 rather than a medium that propagates or transmits program code 718. Computer readable storage media 724 is also referred to as a computer readable tangible storage device or a computer readable physical storage device. In other words, computer readable storage media 724 is a media that can be touched by a person.

Alternatively, program code 718 may be transferred to data processing system 700 using computer readable signal media 726. Computer readable signal media 726 may be, for example, a propagated data signal containing program code 718. For example, computer readable signal media 726 may be an electromagnetic signal, an optical signal, or any other suitable type of signal. These signals may be transmitted over communications links, such as wireless communications links, optical fiber cable, coaxial cable, a wire, or any other suitable type of communications link. In other words, the communications link or the connection may be physical or wireless in the illustrative examples.

In some illustrative embodiments, program code 718 may be downloaded over a network to persistent storage 708 from another device or data processing system through computer readable signal media 726 for use within data processing system 700. For instance, program code stored in a computer readable storage medium in a server data processing system may be downloaded over a network from the server to data processing system 700. The data processing system providing program code 718 may be a server computer, a client computer, or some other device capable of storing and transmitting program code 718.

The different components illustrated for data processing system 700 are not meant to provide architectural limitations to the manner in which different embodiments may be implemented. The different illustrative embodiments may be implemented in a data processing system including components in addition to and/or in place of those illustrated for data processing system 700. Other components shown in FIG. 7 can be varied from the illustrative examples shown. The different embodiments may be implemented using any hardware device or system capable of running program code. As one example, data processing system 700 may include organic components integrated with inorganic components and/or may be comprised entirely of organic components excluding a human being. For example, a storage device may be comprised of an organic semiconductor.

In another illustrative example, processor unit 704 may take the form of a hardware unit that has circuits that are manufactured or configured for a particular use. This type of hardware may perform operations without needing program code to be loaded into a memory from a storage device to be configured to perform the operations.

For example, when processor unit 704 takes the form of a hardware unit, processor unit 704 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 718 may be omitted, because the processes for the different embodiments are implemented in a hardware unit.

In still another illustrative example, processor unit 704 may be implemented using a combination of processors found in computers and hardware units. Processor unit 704 may have a number of hardware units and a number of processors that are configured to run program code 718. With this depicted example, some of the processes may be implemented in the number of hardware units, while other processes may be implemented in the number of processors.

In another example, a bus system may be used to implement communications fabric 702 and may be comprised of one or more buses, such as a system bus or an input/output bus. Of course, the bus system may be implemented using any suitable type of architecture that provides for a transfer of data between different components or devices attached to the bus system.

Additionally, communications unit 710 may include a number of devices that transmit data, receive data, or transmit and receive data. Communications unit 710 may be, for example, a modem or a network adapter, two network adapters, or some combination thereof. Further, a memory may be, for example, memory 706, or a cache, such as found in an interface and memory controller hub that may be present in communications fabric 702.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of illustrative embodiments is presented for purposes of illustration and description and is not intended to be exhaustive or to limit the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of controlling a plurality of different systems on an aircraft, comprising:
connecting a mobile device to an aircraft network on the aircraft, wherein the mobile device is moveable to a plurality of different locations on the aircraft;
receiving, by the mobile device, input from an operator identifying controls for controlling functions performed by the plurality of different systems on the aircraft; and
sending the controls from the mobile device to the plurality of different systems on the aircraft via the aircraft network.

2. The method of claim 1, wherein:
connecting the mobile device to the aircraft network comprises connecting the mobile device to a wireless network on the aircraft via a wireless connection; and
sending the controls from the mobile device to the plurality of different systems on the aircraft comprises sending the controls from the mobile device to the aircraft network via the wireless connection.

3. The method of claim 1, wherein:
connecting the mobile device to the aircraft network comprises connecting the mobile device to the aircraft network via a wired connection; and
sending the controls from the mobile device to the plurality of different systems on the aircraft comprises sending the controls from the mobile device to the aircraft network via the wired connection.

4. The method of claim 1 further comprising:
displaying a plurality of control interfaces for the functions performed by the plurality of different systems on a user interface on the mobile device; and
receiving the input from the operator via the plurality of control interfaces on the user interface.

5. The method of claim 1 further comprising:
receiving, by the mobile device, reports from the plurality of different systems on the aircraft via the aircraft network; and
storing the reports on the mobile device.

6. The method of claim 1 further comprising:
receiving, by the mobile device, reports from the plurality of different systems on the aircraft via the aircraft network; and
displaying the reports on a plurality of report interfaces for the plurality of different systems on a user interface on the mobile device.

7. The method of claim 1, wherein the plurality of different systems on the aircraft are selected from an in-flight entertainment system, a public address system, an information system, a cabin services system, and an attendant call system.

8. An apparatus, comprising:
an aircraft network data processing system on an aircraft, wherein the aircraft network data processing system is configured to:
receive controls for controlling functions performed by a plurality of different systems on the aircraft from a mobile device, wherein the mobile device is moveable to a plurality of different locations on the aircraft; and
deliver the controls received from the mobile device to the plurality of different systems.

9. The apparatus of claim 8, wherein the aircraft network data processing system is configured to receive the controls from the mobile device via a wired connection to the mobile device.

10. The apparatus of claim 8, wherein the aircraft network data processing system is configured to receive the controls from the mobile device via a wireless network.

11. The apparatus of claim 8, wherein the aircraft network data processing system is configured to provide a number of system control applications to the mobile device, wherein the number of system control applications define control interfaces for the functions performed by the plurality of different systems.

12. The apparatus of claim 8, wherein the mobile device is configured to:
display a plurality of control interfaces for the functions performed by the plurality of different systems on a user interface on the mobile device; and
receive input identifying the controls from an operator via the plurality of control interfaces on the user interface.

13. The apparatus of claim 8, wherein the aircraft network data processing system is configured to receive reports from the plurality of different systems and to send the reports to the mobile device.

14. The apparatus of claim 13, wherein the mobile device is configured to display the reports on a plurality of report interfaces for the plurality of different systems on a user interface on the mobile device.

15. The apparatus of claim 13, wherein the mobile device is configured to store the reports on the mobile device.

16. The apparatus of claim 8, wherein the plurality of different systems on the aircraft are selected from an in-flight entertainment system, a public address system, an information system, a cabin services system, and an attendant call system.

17. A method of controlling a plurality of different systems on an aircraft, comprising:
receiving, by an aircraft network data processing system on the aircraft, controls for controlling functions performed by the plurality of different systems on the aircraft from a mobile device, wherein the mobile device is moveable to a plurality of different locations on the aircraft; and
delivering the controls from the mobile device to the plurality of different systems by the aircraft network data processing system.

18. The method of claim 17, wherein receiving the controls from the mobile device comprises receiving the controls from the mobile device via a connection selected from a wired connection and a wireless connection.

19. The method of claim 17 further comprising:
providing a number of system control applications from the aircraft network data processing system to the mobile device, wherein the number of system control applications define control interfaces for the functions performed by the plurality of different systems.

20. The method of claim 17 further comprising:
receiving reports from the plurality of different systems by the aircraft network data processing system; and
sending the reports from the aircraft network data processing system to the mobile device.
